(19) United States
(12) Patent Application Publication
(10) Pub. No.: US 2014/0195731 A1
(43) Pub. Date: Jul. 10, 2014

(54) PHYSICAL LINK MANAGEMENT

(71) Applicant: LSI CORPORATION, San Jose, CA (US)

(72) Inventors: Jeevanandham Rajasekaran, Bangalore (IN); Ankit Sihare, Bangalore (IN)

(73) Assignee: LSI CORPORATION, San Jose, CA (US)

(21) Appl. No.: 13/736,218

(22) Filed: Jan. 8, 2013

(51) Int. Cl. G06F 3/06

(52) U.S. Cl. CPC G06F 3/0619
USPC 711/112

(57) ABSTRACT

Disclosed is a storage system that includes a physical disk and a storage controller. The storage controller is configured to use a first physical link and a second physical link of a serial attached SCSI (SAS) wide port to communicate with the physical disk. Based on a dynamic system property, the storage controller is re-configured to use at least a third physical link of the SAS wide port to communicate with physical disk. Examples of the dynamic system property include load on the SAS wide port, a failure condition, or premium feature enablement.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems. A solution to these increasing demands is the use of arrays of multiple inexpensive disks. These arrays may be configured in ways that provide redundancy and error recovery without any loss of data. These arrays often are interconnected, and/or connected to a host using Serial Attached SCSI (SAS) communication links

SAS is a communication protocol used to move data to and from computer storage devices such as hard drives and tape drives. SAS is a point-to-point serial protocol that displace parallel SCSI bus technology in many computer systems and storage environments. SAS uses the standard SCSI command set. At the physical layer, the SAS standard defines connectors and voltage levels. The physical characteristics of the SAS wiring and signaling are compatible with and have loosely tracked that of serial ATA (SATA). SAS defines more rigorous physical signaling specifications as well as a wider allowable differential voltage swing intended to allow longer cabling.

### SUMMARY OF THE INVENTION

An embodiment of the invention may therefore comprise a method of operating a storage system, comprising: configuring a storage controller to use a first physical link and a second physical link of a serial attached SCSI (SAS) wide port to communicate with a physical disk; based on dynamic system property, configuring the storage controller to use a third physical link of the SAS wide port.

An embodiment of the invention may therefore further a storage system, comprising: a physical disk; a storage controller configured to use a first physical link and a second physical link of a serial attached SCSI (SAS) wide port to communicate with the physical disk, and configured to use a third physical link of the SAS wide port based on a dynamic system property.

### BRIEF DESCRIPTION OF THE DRAWINGS

FIG. 1A is a block diagram of a storage system.

FIG. 1B is an illustration of a storage system dynamically activating links.

FIG. 2 is a flowchart of a method of operating a storage system.

FIG. 3 is a block diagram of a computer system.

### DETAILED DESCRIPTION OF THE EMBODIMENTS

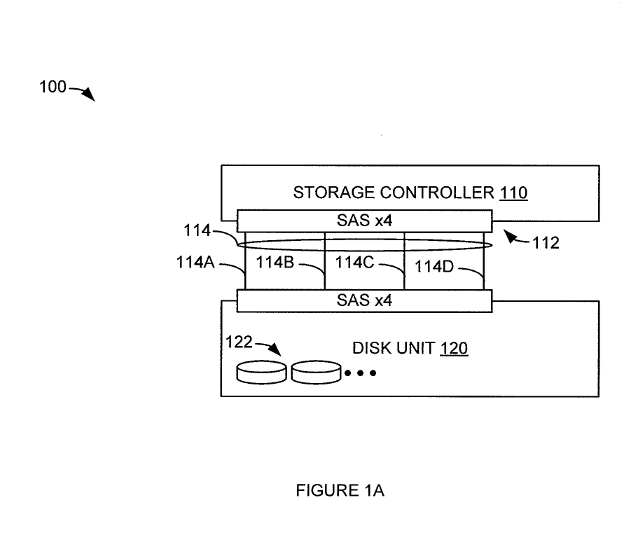

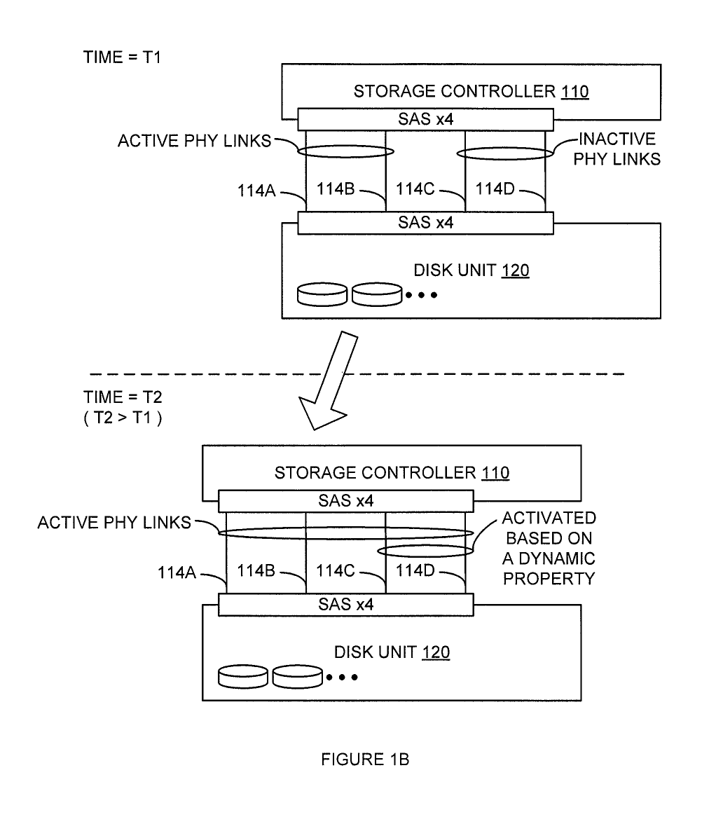

FIG. 1A is a block diagram of a storage system. In FIG. 1A, storage system 100 comprises storage controller 110 and disk unit 120. Storage controller 110 is operatively coupled to disk unit 120 via a SAS wide port 112 and 4 physical (PHY) links 114 (i.e., PHY links 114A, 114B, 114C, and 114D). Disk unit 120 is operatively coupled to PHY links 114.

Storage controller 110 may be, or comprise, controllers that are compatible with or described by, for example, InfiniBand, Redundant Array of Inexpensive Disks (RAID), Network Attached Storage (NAS), Storage Array Network (SAN), iSCSI SAN, or a Virtual Tape Library (VTL), etc. Disk unit 120 may be, or comprise, one or more Just a Bunch Of Disks or Just a Box Of Drives (JBOD) in an enclosure and other hardware such as SAS port expanders.

In an embodiment, storage controller 110 may include parity and ECC generation, battery backed data memory, NVRAM, and inter-controller write cache mirroring. For example, storage controller 110 may allow for nonvolatile caching of write data. This data may be mirrored, thus providing for redundant storage of this cached data. Storage controller 110 may provide commit to disk capability.

Nonvolatile memory in storage controller 110 can provide storage that survives power failures, system shutdowns, etc. This memory may be flash, battery backed memory, or the like. Storage controller 110 may contain nonvolatile memory in order to perform write cache I/O processing to ensure that data will be preserved in the event of a power failure or I/O disruption.

As can be seen in FIG. 1, storage controller 110 is connected to disk unit 120 using four physical links 114A-114D. Generally, a mini-SAS connector consists of four PHYs, in which each PHY consists of pair of transmit (TX) and receive (RX) path. It should be understood that these connections are direct connections and do not pass through a switching fabric or other intermediate device. In another embodiment, storage controller 110 may be connected to disk unit 120 using more than four physical links 114.

Each PHY (Physical layer or Physical link 114A-114D) is a hardware block which is controlled duly by storage controller 110 firmware such as Initiator-Target, Integrated-RAID, iMegaRAID, and/or MegaRAID. In FIG. 1, all of the available PHYs 114 per wide port 112 mini-SAS connector may not be used. This is illustrated in FIG. 1B at time T=T1. In FIG. 1B at time T=T1, 2 PHYs per wide port 112 are active (PHYs 114A and 114B), and 2 PHYs are inactive (PYs 144C and 144D).

Based on some dynamic property (conditions), storage controller 110 may change to a mode in which all the PHYs 114 available per wide port 112 are used. This is illustrated in FIG. 1B at time T=T2. Some example conditions are: (1) the type of connected physical disks (PDs), such as HDD, SSD, SED/FDE, DIF and variable LBA size PDs); (2) a property of Virtual Disks (VDs), such as Read, Write, IO, DiskCache, Fastpath, Load balance, or Cascaded; (3) based on a premium feature key availability at run time; or, (4) topology such as multi-path, single-path, and/or cascaded expander connections. In an embodiment, if the number of logical volumes, system physical disks (PD), JBOD physical disks available disks, or when an I/O load or I/O traffic exceeds a threshold, storage controller 110 may change in to a mode in which all the PHYs 114 available on wide port 112 can be utilized. These PHYs 114 may be used to load level, load balance, fail over, or other features. Storage controller 110 may make sure to utilize all the PHYs 114 in by controlling the PHY hardware units based on a check or condition in its firmware code.

Each SAS PHY 114A-114D may support and control additional devices. Dynamic control of PHY level utilization may be used in such a way to efficiently manage more allowed devices per SAS PHY 114.

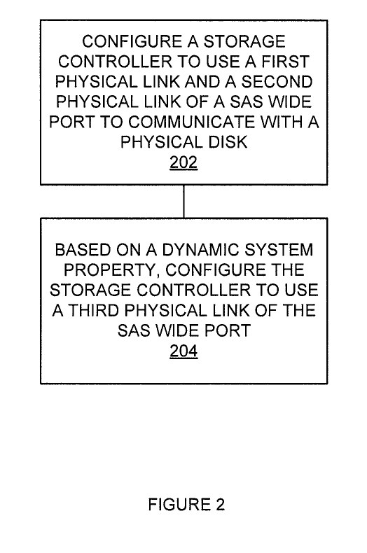

FIG. 2 is a flowchart of a method of operating a storage system. The steps illustrated in FIG. 2 may be performed by one or more elements of storage system 100. A storage controller is configured to use a first physical link and a second physical link of a SAS wide port to communicate with a physical disk (202). For example, storage controller 110 may he configured to use physical links 114A and 114B to communicate with disk unit 120.

Based on a dynamic system property, the storage controller is configured to use a third physical link of the SAS wide port (204). For example, based on a dynamic system property, storage controller 110 may be configured to use physical link 114C (and/or 114D) to communicate with disk unit 120. This dynamic system property can be based on (1) the type of connected physical disks (PDs), such as HDD, SSD, SED/FDE, DIF and variable LBA size PDs); (2) a property of Virtual Disks (VDs) with data stored on disk unit 120, such as Read, Write, IO, DiskCache, Fastpath, Load balance, or Cascaded; (3) a premium feature key availability at run time; or, (4) a topology such as multi-path, single-path, and/or cascaded expander connections. In addition, if the number of logical volumes (virtual disks), system physical disks (PD), JBOD physical disks available disks, or when an I/O load or I/O traffic exceeds a threshold, storage controller 110 may change in to a mode in which all the physical links 114A-114D available on wide port 112 can be utilized. These physical links 114 may be used to load level, load balance, failover, or other features.

In an embodiment, the dynamic system property is based on a type of physical disk coupled to the SAS wide port. In another embodiment, the dynamic system property is based on a topology of a link between said storage controller and said physical disk. In another embodiment, the dynamic system property is based on a property of a virtual disk. In another embodiment, the dynamic system property is based on a failure of said first physical link. For example, if physical link 114A is active and fails, the dynamic system property would be the failure of physical link 114A and storage controller 110 can activate physical link 114D in response.

In another embodiment, the dynamic system property is based on a load on said first physical link. For example, if physical link 114A is active and its load meets a threshold. The dynamic system property would be the meeting of the threshold by physical link 114A and storage controller 110 can activate physical link 114C in response. In another embodiment, the dynamic system property is based on number of physical disk communicating with the storage controller via the SAS wide port. For example, if physical link 114A is active and is communicating with a number of physical disks that meets a threshold. The dynamic system property would be the meeting of the threshold by physical link 114A and storage controller 110 can activate physical link 114C in response.

The systems, controllers, units, drives, devices, equipment, and functions described above may be implemented with or executed by one or more computer systems. The methods described above may also be stored on a computer readable medium. Many of the elements of storage array system 100 may be, comprise, or include computers systems. This includes, but is not limited to storage controller 110, disk unit 120, and any disk drives encompassed in storage array system 100.

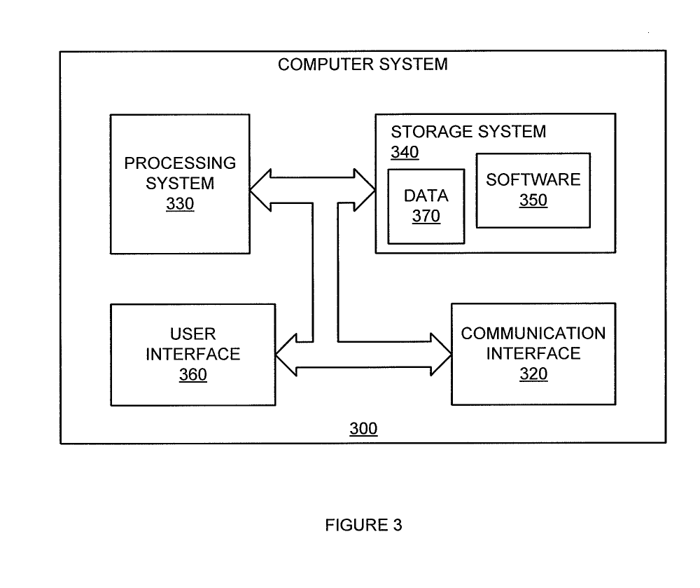

FIG. 3 illustrates a block diagram of a computer system. Computer system 300 includes communication interface 320, processing system 330, storage system 340, and user interface 360. Processing system 330 is operatively coupled to storage system 340. Storage system 340 stores software 350 and data 370. Processing system 330 is operatively coupled to communication interface 320 and user interface 360. Computer system 300 may comprise a programmed general-purpose computer. Computer system 300 may include a microprocessor. Computer system 300 may comprise programmable or special purpose circuitry. Computer system 300 may be distributed among multiple devices, processors, storage, and/or interfaces that together comprise elements 320-370.

Communication interface 320 may comprise a network interface, modem, port, bus, link, transceiver, or other communication device. Communication interface 320 may be distributed among multiple communication devices. Processing system 330 may comprise a microprocessor, microcontroller, logic circuit, or other processing device. Processing system 330 may be distributed among multiple processing devices. User interface 360 may comprise a keyboard, mouse, voice recognition interface, microphone and speakers, graphical display, touch screen, or other type of user interface device. User interface 360 may be distributed among multiple interface devices. Storage system 340 may comprise a disk, tape, integrated circuit, RAM, ROM, network storage, server, or other memory function. Storage system 340 may be a computer readable medium. Storage system 340 may be distributed among multiple memory devices.

Processing system 330 retrieves and executes software 350 from storage system 340. Processing system 330 may retrieve and store data 370. Processing system 330 may also retrieve and store data via communication interface 320. Processing system 330 may create or modify software 350 or data 370 to achieve a tangible result. Processing system 330 may control communication interface 320 or user interface 360 to achieve a tangible result. Processing system 330 may retrieve and execute remotely stored software via communication interface 320.

Software 350 and remotely stored software may comprise an operating system, utilities, drivers, networking software, and other software typically executed by a computer system. Software 350 may comprise an application program, applet, firmware, or other form of machine-readable processing instructions typically executed by a computer system. When executed by processing system 330, software 350 or remotely stored software may direct computer system 300 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of operating a storage system, comprising:
configuring a storage controller to use a first physical link and a second physical link of a serial attached SCSI (SAS) wide port to communicate with a physical disk; and,
based on dynamic system property, configuring the storage controller to use a third physical link of the SAS wide port.

2. The method of claim 1, wherein the dynamic system property is based on a type of physical disk coupled to the SAS wide port.

3. The method of claim 1, wherein the dynamic system property is based on a topology of a link between said storage controller and said physical disk.

4. The method of claim 1, wherein the dynamic system property is based on a property of a virtual disk.

5. The method of claim 1, wherein the dynamic system property is based on a failure of said first physical link.

6. The method of claim 1, wherein the dynamic system property is based on a load on said first physical link.

7. The method of claim 1, wherein the dynamic system property is based on number of physical disk communicating with the storage controller via the SAS wide port.

8. A storage system, comprising:
a physical disk; and,
a storage controller configured to use a first physical link and a second physical link of a serial attached SCSI (SAS) wide port to communicate with the physical disk, and configured to use a third physical link of the SAS wide port based on a dynamic system property.

9. The storage system of claim 8, wherein the dynamic system property is based on a type of physical disk coupled to the SAS wide port.

10. The storage system of claim 8, wherein the dynamic system property is based on a topology of a link between said storage controller and said physical disk.

11. The storage system of claim 8, wherein the dynamic system property is based on a property of a virtual disk.

12. The storage system of claim 8, wherein the dynamic system property is based on a failure of said first physical link.

13. The storage system of claim 8, wherein the dynamic system property is based on a load on said first physical link.

14. The storage system of claim 8, wherein the dynamic system property is based on number of physical disks communicating with the storage controller via the SAS wide port.

15. A non-transitory computer readable medium having instructions stored thereon for operating a storage system that, when executed by a computer, at least instruct the computer to:
use a first physical link and a second physical link of a serial attached SCSI (SAS) wide port to communicate with a physical disk; and,
based on dynamic system property, use a third physical link of the SAS wide port.

16. The medium of claim 15, wherein the dynamic system property is based on a type of physical disk coupled to the SAS wide port.

17. The medium of claim 15, wherein the dynamic system property is based on a topology of a link between said storage controller and said physical disk.

18. The medium of claim 15, wherein the dynamic system property is based on a property of a virtual disk.

19. The medium of claim 15, wherein the dynamic system property is based on a failure of said first physical link.

20. The medium of claim 15, wherein the dynamic system property is based on a load on said first physical link.
